(19) United States
(12) Patent Application Publication
(10) Pub. No.: US 2015/0350041 A1
(43) Pub. Date: Dec. 3, 2015

(54) Protocols & Mechanisms of Comm Between Live Production Server and Mobile or Remote Clients

(71) Applicant: Paladin Innovators, Federal Way, WA (US)

(72) Inventors: Jonathan Clem, Seattle, WA (US); Dean Bisogno, Fort Collins, CO (US)

(21) Appl. No.: 14/291,341

(22) Filed: May 30, 2014

(51) Int. Cl. H04L 12/26; H04L 29/08; H04L 12/927; H04L 7/00; H04L 29/06

(52) U.S. Cl. CPC H04L 43/08; H04L 7/0008; H04L 65/1066; H04L 47/808; H04L 67/02; H04L 67/10

(57) ABSTRACT

Protocols and mechanisms of communication between live production servers and mobile or remote clients are disclosed herein. Implementation of these protocols and mechanisms relies on certain methods to process and answer requests made between the clients and the servers. The essential practice of these protocols and mechanisms is the design of software which allows a video producer to use a thin client to control activity from any location instead of controlling these activities manually while sitting in front of video monitors.

### PRIORITY CLAIM

The present application claims priority from and the benefit of U.S. Provisional Application No. 61/828,785 filed on May 30, 2013 which is herein incorporated by reference.

### DETAILED DESCRIPTION OF THE PREFERRED EMBODIMENT

### General Field and Type of Invention

The invention primarily addresses issues in the professional video production market.

Users might work within churches, community centers, convention centers, as professional videographers, or as news gatherers. Secondary markets include amateur videographers, independent news gatherers, and security providers. Tertiary groups of interest are high end electronics consumers or “prosumers” who might use products leveraging the invention to produce and share videos of their private making.

Composition of the invention is primarily that of communication protocols (or systems) developed by the inventors to control video production software in realtime.

Implementation of these protocols relies on certain methods to process and answer requests made between client and server.

### Commercial Applications

Protocols are necessary when coordinating communication between a client and server. Commercial applications of the invention would allow the user to control software during a live video event from a remote or mobile device.

### Purpose of the Invention

Current video encoding software requires the producer to be sitting in front of the video monitors manually switching which camera is active or which graphical elements should be overlaid at which point in time.

The invention allows the producer to use a thin client such as a mobile device to control this activity from any location.

### Previous Approaches to Accomplish the Same Purpose as this Invention, and Their Limitations

Some software implements a basic protocol over telnet. CasparCG is an example of this model using a telnet based protocol called AMCP. CasparCG's AMCP has no user sessioning ability and is specific to CasparCG. Many firewalls also block telnet by default, requiring firewall exemptions to be made before the software can be used.

Other pieces of software, such as UStream's web producer, have required each camera to be streamed to a Content Distribution Network (CDN) where they are switched on the server via a webpage. This process requires an in-telnet connection and introduces higher or variable latency between different sources.

### DETAILED DESCRIPTION OF THE INVENTION

The essential problems which the invention addresses are how to free the producer/user from sitting in one place during an event, and how to pack complete workstation functionality into a mobile device without requiring workstation computational power. Both of these problems are addressed by establishing a consolidated protocol between client and server which can be used to address multiple pieces of software.

The protocol requires WebSockets as defined by the Internet Engineering Task Force (IETF) in RFC 6455.

The server listens on an arbitrary port for client connection. When a client connects on this port it requests a certain permission level which it will need to take future actions. Authentication can be used before authorizing permissions but this is not necessary.

Once a connection request has been made, the server saves the connection context to a Typed List for future reference.

The server then may send an object of type Response with state information (such as current camera shots, whether archiving or streaming is taking place and any other relevant stateful data).

All client requests to the server have a CommandType. The CommandType of a request received by the server dictates what actions the server might take. Actions could include whether the encoder is currently streaming, recording, or even running, commands might change what video, images, or audio assets are playing in the live video stream, or might control other pieces of pieces of hardware attached to the server such as a video router or audience participation application.

All server responses to the client have a ResponseType. This ResponseType communicates to the client how to handle the response. It may be a new list of shots, or a change in the broadcast or record state.

A client may receive a response without having sent a specific request. This can be done when a second client has initiated a state change and the server is insuring that all clients are synchronized.

### Preferred Embodiments of this Invention

This protocol and it's accompanied mechanisms are best implemented in a thin client application on a mobile device and a centralized video encoding/production system. This allows the client to control the live video production and encoding while remaining mobile.

The most obvious instantiation of this concept is with a mobile device and a powerful workstation with cameras attached to the workstation while the producer can move around the production space with a mobile device and control the workstation.

A more ambitious arrangement would have the workstation residing in a cloud configuration.

The embodiments of the invention in which an exclusive property or privilege is claimed are defined as follows:

1. Tracking user sessions over WebSockets for the purpose of synchronizing client states.

2. Using asynchronous HTTP requests over WebSockets to control server-side software.

3. Establishing user permissions over WebSockets for the purpose of evaluating and controlling which users have access to which functions offered by the software.
